(19) United States
(12) Patent Application Publication
(10) Pub. No.: US 2025/0385522 A1
(43) Pub. Date: Dec. 18, 2025

(54) DIRECT-CURRENT COUPLING SYSTEM AND CHARGING CONTROL METHOD THEREFOR

(71) Applicant: Sungrow Power Supply Co., Ltd., Hefei (CN)

(72) Inventors: Tingkuan Wu, Hefei (CN); Cheng Liang, Hefei (CN); Nianan Pan, Hefei (CN); Yuandong Qian, Hefei (CN); Lei Dong, Hefei (CN); Yunjian Ma, Hefei (CN)

(73) Assignee: Sungrow Power Supply Co., Ltd., Hefei (CN)

(21) Appl. No.: 18/958,218

(22) Filed: Nov. 25, 2024

(30) Foreign Application Priority Data
Jun. 14, 2024 (CN) 202410772072.1

(51) Int. Cl. H02J 3/32; H02J 3/38

(52) U.S. Cl. CPC H02J 3/32; H02J 3/381; H02J 2300/26

(57) ABSTRACT

A direct-current coupling system and a charging control method therefor are provided. In the direct-current coupling system, an alternating-current side of an inverter is configured to connect a power grid, a direct-current side of the inverter is connected to at least one photovoltaic array and at least one energy storage system through a direct-current bus, where the energy storage system includes a battery system and a DC/DC converter connected to the corresponding direct-current bus, so that the DC/DC converter can acquire energy from at least one of the inverter and the photovoltaic array during charging the battery system. The DC/DC converter acquires, in response to a power regulation demand at the alternating-current side, energy from the power grid through the inverter connected to the DC/DC converter during charging the battery system.

The present application claims priority to Chinese Patent Application No. 202410772072.1, titled “DIRECT-CURRENT COUPLING SYSTEM AND CHARGING CONTROL METHOD THEREFOR”, filed on Jun. 14, 2024 with the China National Intellectual Property Administration, which is incorporated herein by reference in its entirety.

### FIELD

The present disclosure relates to the technical field of photovoltaic power generation, and in particular to a direct-current coupling system and a charging control method for the direct-current coupling system.

### BACKGROUND

Generally, a direct-current side of a photovoltaic inverter is only connected to a photovoltaic panel, and thus there is only a discharging scenario where the direct-current side of the photovoltaic inverter transmits power to the power grid without considering a charging scenario where the power grid transmits power to the direct-current side of the photovoltaic inverter. In a direct-current coupling system, that is, a direct-current side of an inverter is connected to the photovoltaic panel and an energy storage system, the power grid may transmit power to the direct-current side of the inverter. In such case, both the photovoltaic panel and the power grid may charge the energy storage system.

However, a charging strategy for the direct-current coupling system is currently only applicable to a scenario of a lower requirement on a charging power and a response speed at an alternating-current side of the power grid, thus limiting the application scenario of the direct-current coupling system.

### SUMMARY

In view of this, a direct-current coupling system and a charging control method for the direct-current coupling system are provided in the present disclosure, to improve the charging power and the response speed, to maximize the power response capability at the alternating-current side of the inverter, and to expand the application scenario.

In order to achieve the above objectives, the following technical solutions are provided according to the present disclosure.

In a first aspect, a direct-current coupling system is provided in the present disclosure. The direct-current coupling system includes at least one inverter, at least one photovoltaic array, and at least one energy storage system, where an alternating-current side of the at least one inverter is configured to connect a power grid; and a direct-current side of the at least one inverter is connected to the at least one photovoltaic array and the at least one energy storage system through a corresponding direct-current bus; the at least one energy storage system includes a battery system and a direct-current/direct-current (DC/DC) converter, and the battery system is connected to a direct-current bus through the DC/DC converter; and the DC/DC converter is configured to acquire, in response to a power regulation demand at the alternating-current side, energy from the power grid through the inverter connected to the DC/DC converter during charging the battery system.

In a second aspect, a charging control method for a direct-current coupling system is provided in the present disclosure, applied to any direct-current coupling system according to the first aspect, where the at least one photovoltaic array in the direct-current coupling system is connected to the at least one inverter during charging the battery system, and during charging the battery system, the charging control method includes: determining, by the at least one inverter, a second voltage for a charging balance of the battery system and a first voltage in a real time manner, and sending, by the at least one inverter, the second voltage to respective DC/DC converter connected to the at least one inverter, where the first voltage is greater than the second voltage; controlling the at least one inverter to operate on condition that the first voltage serves as a predetermined bus voltage value of the inverter; and controlling the DC/DC converter to operate on condition that the second voltage serves as a predetermined bus voltage value of the DC/DC converter.

In a third aspect, a charging control method for a direct-current coupling system is provided in the present disclosure, applied to any direct-current coupling system according to the first aspect, where the at least one photovoltaic array in the direct-current coupling system is connected to the direct-current bus through a direct-current switch, and during charging the battery system, the charging control method includes turning off the direct-current switch by the at least one inverter in the direct-current coupling system; and controlling by the at least one inverter, a bus voltage of the inverter in a constant voltage technology tracking mode.

### BRIEF DESCRIPTION OF THE DRAWINGS

In order to more clearly illustrate technical solutions in embodiments of the present disclosure or in the conventional technology, drawings to be used in the description of the embodiments or the conventional technology are briefly described below. Apparently, the drawings in the following description show only some embodiments of the present disclosure, and other drawings may be obtained by those skilled in the art from the drawings without any creative work.

FIG. 1 is a schematic structural diagram of a direct-current coupling system according to an embodiment of the present disclosure;

FIG. 2 is a schematic structural diagram of a direct-current coupling system according to another embodiment of the present disclosure;

FIG. 3 is a schematic structural diagram of a direct-current coupling system according to another embodiment of the present disclosure;

FIG. 4 is a schematic structural diagram of a direct-current coupling system according to another embodiment of the present disclosure;

FIG. 5 is a flowchart of a charging control method for a direct-current coupling system according to an embodiment of the present disclosure;

FIG. 6 is a flowchart of a charging control method for a direct-current coupling system according to another embodiment of the present disclosure; and

FIG. 7 is a flowchart of a charging control method for a direct-current coupling system according to another embodiment of the present disclosure.

### DETAILED DESCRIPTION

The technical solutions according to the embodiments of the present disclosure are described clearly and completely hereinafter in conjunction with the drawings in the embodiments of the present disclosure. It is apparent that the described embodiments are only some of the embodiments according to the present disclosure, rather than all the embodiments. Any other embodiments obtained by those skilled in the art based on the embodiments of the present disclosure without any creative work fall within the protection scope of the present disclosure.

The terms “include”, “comprise” or any other variants thereof are intended to be non-exclusive. Therefore, a process, method, article or device including a series of elements include not only these elements but also other elements that are not clearly enumerated, or further include elements inherent in the process, method, article or device. Unless expressively limited, the statement “including a . . . ” does not exclude the case that other similar elements may exist in the process, method, article or device including the series of elements.

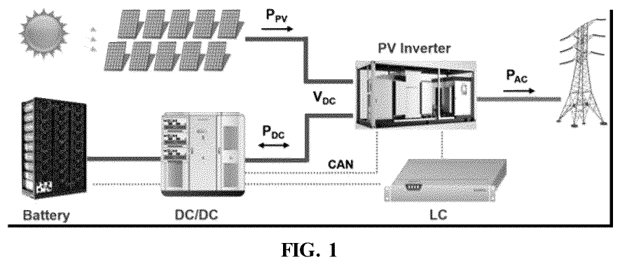

As the large energy base becomes a major support of renewable energy development, an application of a direct-current coupling photovoltaic storage joint project with flexible expansion is continuously increased. FIG. 1 illustrates a block diagram of a direct-current coupling system. A battery system (represented by Battery shown in FIG. 1) is connected to a direct-current side of an inverter (represented by PV Inverter shown in FIG. 1) through a DC/DC converter (represented by DC/DC shown in FIG. 1). A photovoltaic array is directly connected to the direct-current side of the inverter. An alternating-current side of the inverter is configured to connect the power grid. The inverter is communicatively connected to the DC/DC converter through CAN communication. The inverter and the DC/DC converter are communicatively connected to a local controller (represented by LC shown in FIG. 1). Where V_{DC} represents a voltage of the direct-current side of the inverter, P_{DC} represents power transmitted between the DC/DC converter and the direct-current side of the inverter, P_{PV} represents power transmitted from the photovoltaic array to the direct-current side of the inverter, and P_{AC} represents power transmitted between the alternating-current side of the inverter and the power grid.

In the structure shown in FIG. 1, during charging the battery system, the DC/DC converter may acquire energy from at least one of the photovoltaic array and the inverter. In a case that the energy is preferentially acquired from the photovoltaic array, if the battery system fails to accommodate grid power provided by the inverter when frequency regulation occurs, the frequency regulation may fail. In a case that the energy is proportionally acquired from the photovoltaic array and the inverter, the inverter may not transmit charging power in response to the frequency regulation in a real time manner. Therefore, the above solution is not applicable to a scenario where the charging power and the charging speed at the alternating-current side of the inverter are highly required, for example, Australian Frequency Control Ancillary Services (FCAS) markets.

In addition, the above solution fails to timely regulate the energy acquired from the power grid based on a change in an electricity price of the power grid, resulting in high charging cost.

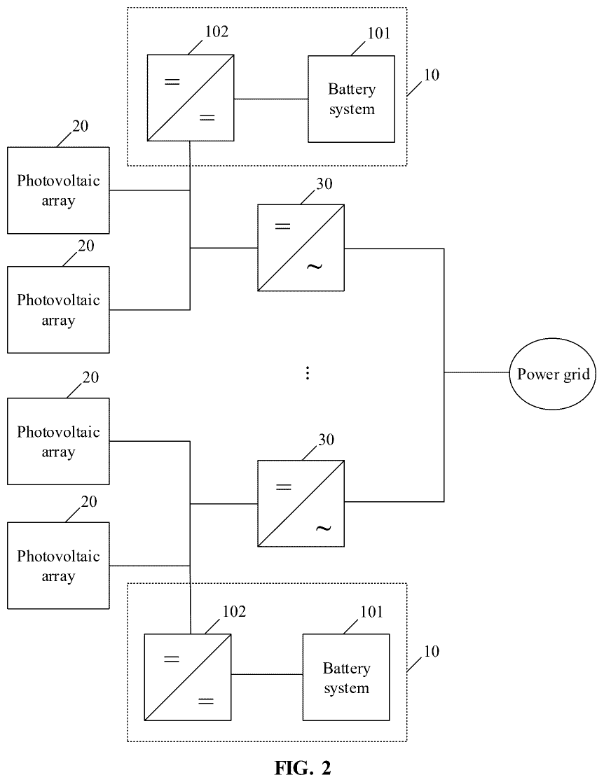

The control of the charging power and the charging speed of the alternating-current side of the inverter directly affect the frequency regulation capability and the charging cost of the system. Therefore, in order to improve the charging power and the response speed at the alternating-current side of the inverter, to maximize the power response capability of the alternating-current side of the inverter, and to expand the application scenario, a direct-current coupling system is provided according to the present disclosure. As shown in FIG. 2, the direct-current coupling system includes at least one inverter 30, at least one photovoltaic array 20, and at least one energy storage system 10.

An alternating-current side of the inverter 30 is configured to connect a power grid. In practice, the alternating-current side of the inverter 30 may be connected to the power grid through a step-up transformer.

A direct-current side of the inverter 30 is connected to the at least one photovoltaic array 20 and the at least one energy storage system 10 through a direct-current bus. FIG. 2 illustrates an example in which the direct-current side of each inverter 30 is connected to two photovoltaic arrays 20 and one energy storage system 10. In practice, the number of the photovoltaic array 20 connected to each inverter 30 and the number of the energy storage system 10 connected to each inverter 30 each are not limited, depending on the application environment.

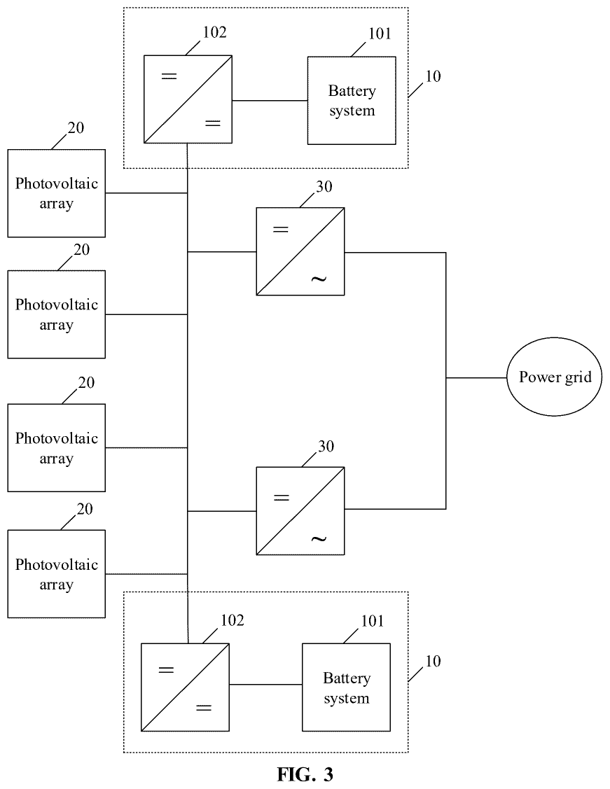

It should be noted that, in practice, the number of the inverter 30 may be one or more. As shown in FIG. 2, the number of the inverter 30 is more than one, each inverter 30 may independently operate. Alternatively, as shown in FIG. 3, two inverters 30 may be integrated into one device, and each of the inverters 30 serves as an inverter unit in the device, and direct-current sides of the inverters 30 are connected in parallel in the device, that is, the inverters 30 share a same direct-current bus. FIG. 3 illustrates an example in which two inverters 30 are integrated. In practice, more inverters 30 may be integrated, which is not limited here, depending on the application environment.

In addition, the energy storage system 10 includes a battery system 101 and a DC/DC converter 102, and the battery system 101 is connected to a direct-current bus through the DC/DC converter 102. Generally, the DC/DC converter 102 receives a power direction and a voltage sent by the corresponding inverter 30, and operates based on the power direction and the voltage, achieving charge and discharge of the battery system 101. The DC/DC converter 102 is communicatively connected to the corresponding inverter 30. In practice, the DC/DC converter 102 and the inverter 30 may be communicatively connected to the local controller LC.

A frequency regulation process of the power grid or a process of timely regulation of the energy acquired from the power grid based on the electricity price of the power grid is equivalent to a power response process at the alternating-current side of the inverter 30. Therefore, in this embodiment, the DC/DC converter 102 acquires energy from the power grid (simply referred to as power grid energy) through the inverter connected to the DC/DC converter to charge the battery system 101 on condition that the DC/DC converter 102 and the inverter 30 respond to a power regulation demand at the alternating-current side of the inverter 30. The power regulation demand at the alternating-current side refers to a frequency regulation demand or a regulation demand of the energy acquired from the power grid based on the electricity price of the power grid.

In practice, in a case that the power at the alternating-current side of the inverter 30 responding to the power regulation demand at the alternating-current side is less than or equal to a charging power of the battery system 101, the power regulation demand at the alternating-current side is met during charging the battery system 101. In a case that the power of the alternating-current side of the inverter 30 responding to the power regulation demand at the alternating-current side is greater than the charging power of the battery system 101, the power grid energy is used for responding to the power regulation demand at the alternating-current side, which can greatly meet the power regulation demand at the alternating-current side. That is, compared with preferentially using the energy outputted by the photovoltaic array 20, in this embodiment, the DC/DC converter 102 is configured to preferentially acquire the power grid energy, maximizing the power grid energy accommodated by the battery system 101, thereby greatly responding to the power regulation demand at the alternating-current side of the corresponding inverter 30. For each energy storage system 10 shown in FIG. 2 and FIG. 3, the DC/DC converter 102 may preferentially acquire the power grid energy outputted by the inverter 30 connected to the DC/DC converter to charge the battery system 101 of the energy storage system 10.

In the direct-current coupling system according to the embodiment, the battery system 101 is charged preferentially by using the power grid energy outputted by the inverter 30 in a case that the DC/DC converter 102 receives energy from at least one of the inverter 30 and the photovoltaic array 20, maximizing a power regulation margin at the alternating-current side of the inverter 30, that is, maximizing the power response capability at the alternating-current side of the inverter, meeting a higher requirement on the charging power and the response speed, for example, responding to the frequency regulation demand in a real time manner, or achieving off-peak charging, optimizing the charging time of the battery system 101, and reducing the charging cost of the system, thereby expanding the application scenario.

Based on the above embodiment, in this embodiment, an example that the DC/DC converter 102 in the direct-current coupling system charges the battery system 101 preferentially by using the power grid energy is described in detail. For example, during charging the battery system 101, if the energy acquired from the power grid is not sufficient for the energy required by the battery system 101, the DC/DC converter 102 acquires remaining energy required by the battery system 101 from the photovoltaic array 20. The energy acquired from the power grid refers to energy acquired from the power grid by the inverter 30 connected to the DC/DC converter 102 in response to the power regulation demand at the alternating-current side.

That is, the DC/DC converter 102 preferentially acquires energy from the inverter 30 in response to the power regulation demand at the alternating-current side, and the remaining energy required by the battery system 101 is provided by the photovoltaic array 20. For example, if the energy from the power grid by the inverter 30 in response to the power regulation demand at the alternating-current side is sufficient for the energy required by the battery system 101, no power is outputted from the photovoltaic array 20. Only if the power grid energy provided by the inverter 30 in response to the power regulation demand at the alternating-current side is not sufficient for the energy required by the battery system 101, the photovoltaic array 20 outputs power to provide the remaining energy. The inverter 30 provides power to charge the battery system 101 in response to the power regulation demand at the alternating-current side such as the frequency regulation demand in a real time manner. In this case, if the battery system 101 further needs large power, the photovoltaic array 20 outputs relatively large power, to supplement the remaining power. If the battery system 101 further needs small power, the output power of the photovoltaic array 20 only needs to meet a small power demand. If the power provided by the inverter 30 just meets the charging demand of the battery system 101, that is, the battery system 101 no longer needs a power supplement, no power is outputted from the photovoltaic array 20.

In practice, both the inverter 30 and the DC/DC converter 102 have respective voltage loops, and a direct-current bus voltage (simply referred to as a bus voltage) may be regulated by the two voltage loops, that is, both references of the two voltage loops are respective predetermined bus voltage values. Therefore, in order to achieve the above functions, the two predetermined bus voltage values compete for the control of the bus voltage. In an embodiment, the predetermined bus voltage value of the inverter 30 is set to a value X, and the predetermined bus voltage value of the DC/DC converter 102 is set to a value Y, where the value X is greater than the value Y.

In a case that the battery system 101 completely absorb the energy of the inverter 30, and maximum power currently outputted by the inverter 30 fails to meet the demand of the battery system 101, the inverter 30 is in a constant power saturation state due to X>Y, and fails to regulate the bus voltage to the predetermined bus voltage value X of the inverter 30, instead, the bus voltage is controlled by the DC/DC converter 102. That is, the direct-current bus voltage is controlled by the predetermined bus voltage value Y of the DC/DC converter 102. In a case that the battery system 101 fails to completely absorb the energy of the inverter 30, the DC/DC converter 102 enters a saturation state and loses the control of the bus voltage. In this case, the bus voltage is automatically increased, and then the bus voltage is controlled by the inverter 30, that is, the bus voltage is controlled by the predetermined bus voltage value X of the inverter 30. In addition, if the battery system 101 is fully charged, the DC/DC converter 102 is turned off. In an embodiment, the DC/DC converter 102 is manually turned off. In another embodiment, the DC/DC converter 102 is automatically turned off by the inverter 30 or the local controller LC shown in FIG. 1, depending on the application environment. All the implementations fall within the protection scope of the present disclosure.

In practice, the two predetermined bus voltage values may be set separately, in order to ensure that the value X is greater than the value Y. In an embodiment, the predetermined bus voltage value Y of the DC/DC converter 102 may be set to a voltage for achieving the charging balance of the battery system 101, that is, a system balance voltage, such as, an MPPT voltage of the photovoltaic array 20 connected to the DC/DC converter 102. In addition, the inverter 30 detects the predetermined bus voltage value Y based on an MPPT strategy, and then transmits the predetermined bus voltage value Y to the DC/DC converter 102. In the MPPT strategy, operation parameters of the photovoltaic array 20 are monitored and regulated in a real time manner to maximize the output power of the photovoltaic array 20, that is, the photovoltaic array 20 always operates at a maximum power point, thereby improving the energy conversion efficiency. The MPPT voltage is a voltage of the photovoltaic array 20 operating at the maximum power point. The predetermined bus voltage value X of the inverter 30 may be positively correlated with the output power of the photovoltaic array 20 connected to the inverter 30, and may be a maximum system voltage. For example, the predetermined bus voltage value X of the inverter 30 is set to a default value when the system is powered on. In an embodiment, the predetermined bus voltage value X of the inverter 30 is set to a high voltage derating lower threshold of the inverter, and is regulated based on the output power of the photovoltaic array 20 connected to the inverter 30. In a case that the output power of the photovoltaic array 20 connected to the inverter 30 is outside a preset fluctuation range including zero, the predetermined bus voltage value X of the inverter 30 is only increased or only decreased with a preset step size based on a previous predetermined bus voltage value X. In a case that the output power of the photovoltaic array 20 connected to the inverter 30 is within the preset fluctuation range, that is, the photovoltaic array 20 has a small output power or absorption power, the predetermined bus voltage value X is an open circuit voltage of the photovoltaic array 20 connected to the inverter 30. In this case, the bus voltage of the inverter 30 may be controlled in an open constant voltage technology (OCVT) mode, that is, the predetermined bus voltage value X may be detected by the inverter 30 based on the OCVT strategy. In practice, the maximum system voltage is not limited to the high voltage derating lower threshold and the open circuit voltage, and may be a value between the two. In addition, the step size may be determined based on the output power rating of the photovoltaic array, which is not limited here, depending on the application environment.

Further, the predetermined bus voltage value X of the inverter 30 may be set to be within a preset range, in order to prevent the predetermined bus voltage value X from being increased or decreased to be too large or too small. In practice, an upper limit and a lower limit of the preset range may be set based on the actual application condition. For example, the upper limit of the preset range may be set to the high voltage derating lower threshold of the inverter, thus avoiding the high voltage derating at the direct-current side of the inverter 30. The lower limit of the preset range may be set to an over-adjustment threshold of the inverter 30, thus avoiding over-adjustment. In practice, the high voltage derating lower threshold and the over-adjustment threshold are not limited, depending on the application environment. All the implementations fall within the protection scope of the present disclosure.

Through the OCVT strategy, the predetermined bus voltage value X may be controlled to be the maximum system voltage in a current condition. For example, the predetermined bus voltage value X is the high voltage derating lower threshold in an initial condition or under a condition of reaching an upper limit of adjustment, preventing the inverter 30 from operating at power derating. In other cases, the energy obtained from the photovoltaic array 20 is minimized, and the power grid energy is preferentially used, so as to greatly meet the power regulation demand at the alternating-current side.

In the foregoing solution, the battery system 101 is charged preferentially by using the power grid energy, improving the charging power and the response speed under a high frequency regulation demand such as FCAS. For example, the frequency regulation may be responded within one second, and thus this solution may be referred to as a one-second frequency regulation solution. Further, the bus voltage is controlled by the DC/DC converter 102, so that the remaining energy required by the battery system 101 can be provided by the photovoltaic array 20. Further, the inverter 30 competes with the DC/DC converter 102 for the control of the bus voltage to achieve the corresponding energy scheduling.

It should be noted that, in a charging scenario, in a case that a charging power required by the battery system 101 is less than the power of the alternating-current side of the inverter 30 or the battery system 101 is fully charged, excess energy outputted by the inverter 30 flows into the photovoltaic array 20. The energy flowing into the photovoltaic panel in the photovoltaic array 20 for a long time may cause the photovoltaic panel to heat, affecting the efficiency of the photovoltaic panel, and even causing a serious damage to the photovoltaic panel.

In the foregoing solution according to the embodiment, in a case that the battery system 101 fails to completely absorb the power grid energy due to a small capacity of the battery system 101, limitation of state of charge (SoC) or the like, the bus voltage is raised based on the above principle to actively prevent the energy at the alternating-current side of the inverter 30 from being transmitted to the direct-current side of the inverter 30, preventing the photovoltaic panel from being subjected to energy backflow, thereby protecting the photovoltaic panel.

It should be noted that the one-second frequency regulation solution is implemented by the inverter 30 competing with the DC/DC converter 102 for the control of the bus voltage, and a voltage for controlling a bus voltage (i.e., the predetermined bus voltage value X) of the inverter 30 is greater than a voltage for controlling a bus voltage (i.e., the predetermined bus voltage value Y) of the DC/DC converter 102. The bus voltage is automatically raised as the available charging power of the DC/DC converter 102 is decreased. The bus voltage may be raised to the predetermined bus voltage value X of the inverter 30. The DC/DC converter 102 may be turned off if the battery system 101 is fully charged. The bus voltage is automatically decreased as the available charging power of the DC/DC converter 102 is increased. If the grid power provided by the inverter 30 is decreased due to insufficient illumination or limited charging power at the alternating-current side of the inverter 30, the bus voltage is automatically stable at the predetermined bus voltage value Y of the DC/DC converter, such as a power balance point of the system. Therefore, this solution leads to a problem of reducing a frequency regulation capability for a photovoltaic over-distribution site due to the high voltage derating of the bus and the regulation saturation.

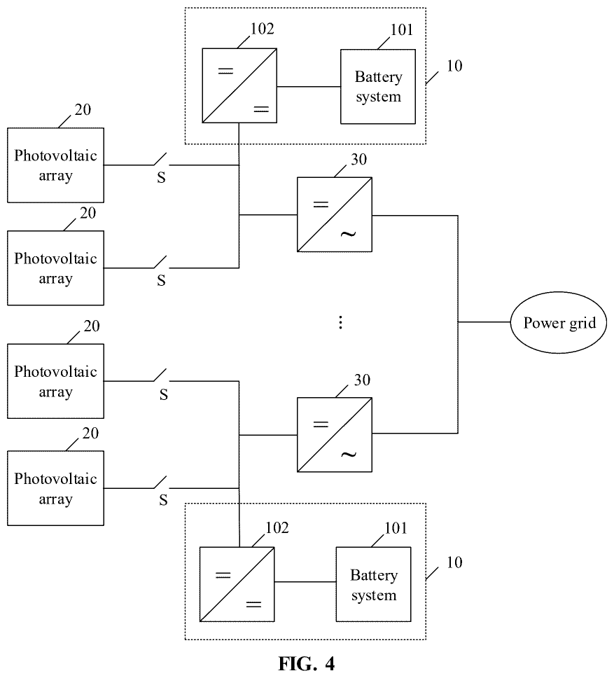

Therefore, another example in which the DC/DC converter 102 charges the battery system 101 preferentially by using the power grid energy in the direct-current coupling system is described below. For example, based on the direct-current coupling system shown in FIG. 1 to FIG. 3, as shown in FIG. 4 (based on FIG. 2), the system further includes a direct-current switch S arranged between the photovoltaic array 20 and the corresponding direct-current bus. Furthermore, each direct-current switch S connected to the corresponding direct-current bus is off during charging the battery system 101. In an embodiment, each direct-current switch S may be turned off when a power of a device connected to the direct-current switch S is zero in order to reduce a turn-off current of the direct-current switch S. For example, the inverter 30 may be first controlled to operate at zero power, the DC/DC converter 102 connected to a same direct-current bus is on standby, and then the direct-current switch S connected to the direct-current bus is turned off.

In practice, the bus voltage of the inverter 30 is controlled in a constant voltage technology (CVT) mode during charging the battery system 101. Before this, the bus voltage of the inverter 30 may be controlled in a control mode (that is, an MPPT mode) under an MPPT strategy, or in the above OCVT mode, depending on the application environment. All the implementations fall within the protection scope of the present disclosure.

In addition, in the embodiment as described above, if the battery system 101 is fully charged, the DC/DC converter 102 connected to the battery system 101 may be manually and/or automatically turned off.

In the solution, after entering the frequency regulation mode, the direct-current switch S connected to the inverter 30 is first turned off, and then energy scheduling is performed by switching an outer voltage loop control mode (i.e., the above bus voltage control mode) to the CVT mode. The frequency regulation may be responded within six seconds, and thus the solution is referred to as a six-second frequency regulation solution. In addition, in this solution, the direct-current switch S is turned off, thereby preventing the photovoltaic panel from being subjected to energy backflow. Moreover, during frequency regulation scheduling in the CVT mode, the inverter 30 automatically regulates the charging power based on a demand of the battery system 101, thus solving the problems of high voltage derating of the bus and the regulation saturation without reducing the frequency regulation capability.

It should be noted that, the battery system 101 is charged preferentially by using the energy at the alternating-current side of the inverter 30 based on the one-second frequency regulation solution and the six-second frequency regulation solution. The one-second frequency regulation solution is that the charging power at the alternating-current side is actively reduced in the OCVT mode in a case that the battery system 101 fails to completely absorb the power grid energy, to protect the photovoltaic panel. The six-second frequency regulation solution is that the direct-current switch S is directly turned off, to protect the photovoltaic panel. Both the two solutions can solve the problem that the photovoltaic panel is subjected to energy backflow, thus protecting the photovoltaic panel. Moreover, the two solutions can meet the high frequency regulation demand of the Australian FCAS markets in the daytime, so that the inverter 30 can complete the scheduling response of reverse switching of the maximum positive power and maximum negative power at the alternating-current side within 200 ms.

A charging control method for a direct-current coupling system is further provided according to another embodiment of the present disclosure, applied to the direct-current coupling system according to any one of the above embodiments. The photovoltaic array in the direct-current coupling system is connected to the inverter during charging the battery system, that is, the charging control method is applicable to the direct-current coupling system shown in FIG. 1 to FIG. 3 for the one-second frequency regulation solution.

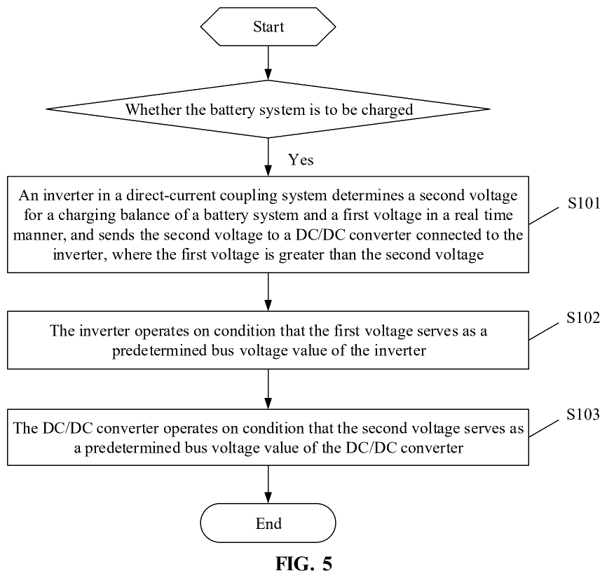

As shown in FIG. 5, the charging control method includes the following steps S101 to S103 on condition that the battery system is to be charged.

In step S101, the inverter in the direct-current coupling system determines a second voltage for a charging balance of the battery system and a first voltage in a real time manner, and sends the second voltage to the DC/DC converter connected to the inverter.

The first voltage is greater than the second voltage.

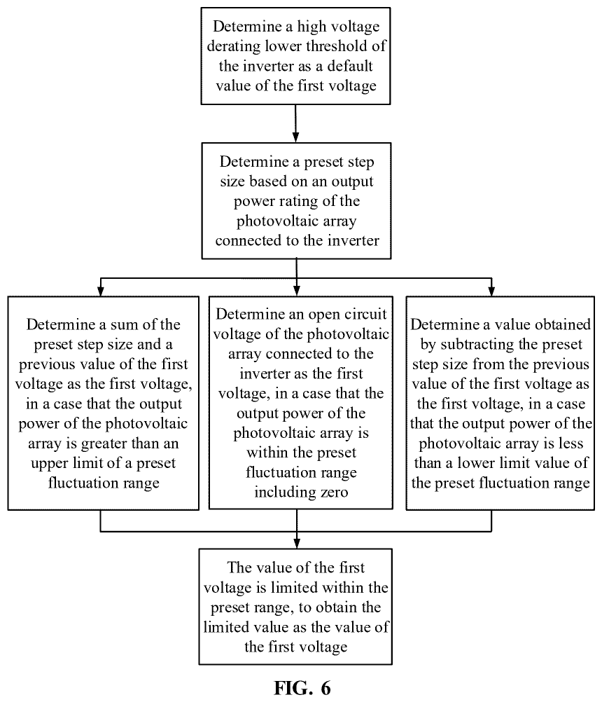

In addition, the process of determining the first voltage in a real time manner may include: determining a maximum system voltage under a current condition as the first voltage. Detailed process of determining the maximum system voltage under the current condition as the first voltage includes the following steps 1 to 3 shown in FIG. 6.

In step 1, a high voltage derating lower threshold of the inverter is determined as a default value of the first voltage.

In step 2, the first voltage is regulated in a real time manner based on an output power of the photovoltaic array connected to the inverter.

Detailed process of step 2 includes as follows. A preset step size is determined based on an output power rating of the photovoltaic array connected to the inverter. In a case that the output power of the photovoltaic array connected to the inverter is greater than an upper limit of the preset fluctuation range including zero, a sum of the preset step size and a previous first voltage is determined as the first voltage. In a case that the output power of the photovoltaic array connected to the inverter is less than a lower limit of the preset fluctuation range, a value obtained by subtracting the preset step size from the previous first voltage is determined as the first voltage. In a case that the output power of the photovoltaic array connected to the inverter is within the preset fluctuation range including zero, an open circuit voltage of the photovoltaic array connected to the inverter is determined as the first voltage.

In practice, the output power rating of the photovoltaic array may be determined based on sampled electrical parameters on site. For example, a direction and a magnitude of the power of the photovoltaic array may be calculated from sampling results obtained by a voltage sensor and a current sensor on the direct-current side of the inverter, and the logic determination is performed based on the direction and the magnitude of the power of the photovoltaic array to determine the first voltage.

In step 3, the first voltage is limited within the preset range to obtain a limited value, and the limited value is determined as the first voltage.

The upper limit and the lower limit of the preset range may be referred to the above embodiments, which are not repeated herein.

In addition, the process of determining the second voltage for a charging balance of the battery system in a real time manner includes: detecting a MPPT voltage of the photovoltaic array connected to the DC/DC converter in a real time manner based on the MPPT strategy, and determining the MPPT voltage as the second voltage. The second voltage is merely an example and is not limited here, as long as the second voltage can achieve the charging balance of the battery system.

In step S102, the inverter operates on condition that the first voltage serves as a predetermined bus voltage value of the inverter.

In addition, during the process of step S102, the inverter may further respond to the power regulation demand at the alternating-current side in the foregoing embodiment. For example, the inverter transmits charging power in response to the frequency regulation for frequency regulation or regulates the power of the alternating-current side of the inverter based on the electricity price of the power grid.

In step S103, the DC/DC converter operates on condition that the second voltage serves as a predetermined bus voltage value of the DC/DC converter.

In combination with the foregoing embodiment, detailed process of the charging control method are described as follows.

The inverter first detects the first voltage based on the above OCVT strategy, and determines the first voltage as the predetermined bus voltage value X of the inverter. Further, the inverter detects the second voltage based on a strategy for the charging balance of the battery system such as the MPPT strategy, and sends the second voltage to the DC/DC converter as the predetermined bus voltage value of the DC/DC converter through communication.

The predetermined bus voltage value X serves as a reference of a voltage loop of the inverter, to control the voltage loop of the inverter, thus controlling the power grid energy received by the alternating-current side of the inverter to preferentially charge the battery system, so that the battery system is charged preferentially by using the power grid energy, greatly meeting the power regulation demand at the alternating-current side in the foregoing embodiment. The DC/DC converter is set to a constant voltage mode and controls energy transmission based on the predetermined bus voltage value Y, so that the bus voltage is controlled at the power balance point, that is, the bus voltage is controlled to be around the predetermined bus voltage value Y, and the energy outputted by the photovoltaic array provides the remaining energy required by the battery system.

Moreover, the inverter competes with the DC/DC converter for the control of the bus voltage. In a case that the battery system completely absorbs the power grid energy transmitted by the inverter, the voltage loop of the DC/DC converter obtains the control of the bus voltage through competition, the inverter operates in a constant current mode, and the bus voltage is around the predetermined bus voltage value Y. The predetermined bus voltage value X is the first voltage detected by the inverter through the OCVT strategy in a real time manner, and the first voltage is greater than the second voltage as the predetermined bus voltage value Y. Therefore, in a case that the battery system fails to completely absorb the power grid energy transmitted by the inverter, the inverter rapidly controls the predetermined bus voltage value X to control the bus voltage, and the DC/DC converter is automatically switched to the constant current mode, so that the bus voltage is raised. In an embodiment, the bus voltage is rapidly increased from the predetermined bus voltage value Y to the predetermined bus voltage value X, thereby preventing the energy at the alternating-current side of the inverter from being transmitted to the direct-current side, and preventing the photovoltaic panel from being subjected to energy backflow.

According to the charging control method according to the embodiment, the battery system is charged preferentially by using the power grid energy, and the remaining available charging power of the battery system is provided by the photovoltaic array, so that the charging power and the response speed of the direct-current coupling system can meet a higher requirement. In addition, in a case that the battery system fails to completely absorb the power grid energy, the bus voltage can be rapidly raised through competition of controllers for the bus voltage, thereby preventing the energy at the alternating-current side of the inverter from being transmitted to the direct-current side, and protecting the photovoltaic panel.

A charging control method for a direct-current coupling system is further provided according to another embodiment of the present disclosure, applied to the direct-current coupling system according to any one of the above embodiments. The photovoltaic array in the direct-current coupling system is connected to a direct-current bus through a direct-current switch, that is, the charging control method is applicable to the direct-current coupling system shown in FIG. 4 for the above six-second frequency regulation solution.

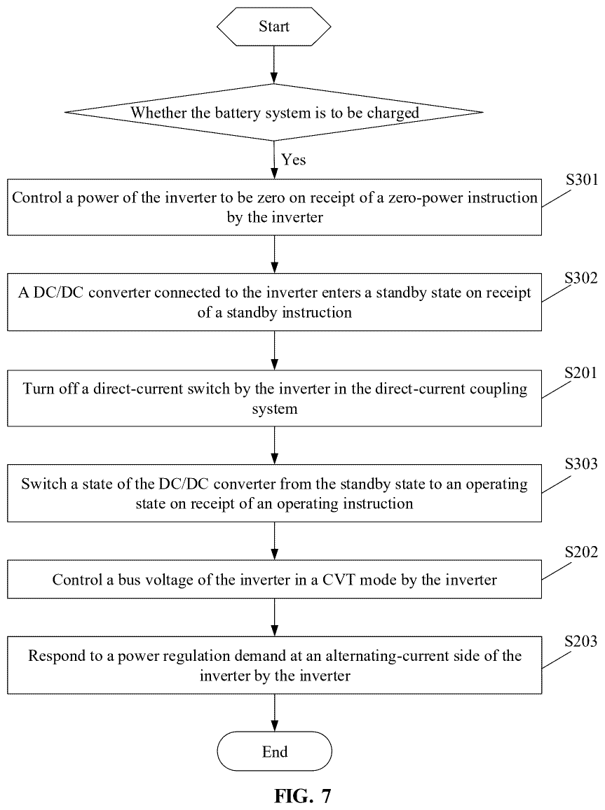

As shown in FIG. 7, the charging control method includes the following steps S201 to S203 during charging the battery system.

In step S201, the direct-current switch is turned off by the inverter in the direct-current coupling system.

In step S202, the inverter controls a bus voltage of the inverter in the CVT mode.

After step S202, the charging control method may further includes step S203.

In step S203, the inverter responds to the power regulation demand at the alternating-current side of the inverter.

During responding to the power regulation demand at the alternating-current side of the inverter, the inverter transmits charging power in response to the frequency regulation for frequency regulation or regulates the power of the alternating-current side of the inverter based on the electricity price of the power grid.

In an embodiment, in order to reduce the turn-off current when the direct-current switch is turned off, before step S201, the charging control method further includes the following steps S301 and S302.

In step S301, the inverter controls a power of the inverter to be zero on receipt of a zero-power instruction.

In step S302, the DC/DC converter connected to the inverter enters a standby state on receipt of a standby instruction.

In addition, after step S201, the charging control method further includes the following step S303.

In step S303, a state of the DC/DC converter is switched from the standby state to an operating state on receipt of an operating instruction. In an embodiment, the charging control method includes the following steps 1 to 6.

In step 1, the inverter reduces the power of the inverter to be zero on receipt of the zero-power instruction.

In step 2, the DC/DC converter enters the standby state.

In step 3, the direct-current switch is turned off.

In step 4, the DC/DC converter is switched from the standby state to the operating state.

In step 5, the inverter is switched from the MPPT mode or the OCVT mode to the CVT mode.

In step 6, the inverter transmits charging power in response to the frequency regulation for frequency regulation.

In the charging control method according to the embodiment, the direct-current switch is turned off, the battery system is charged preferentially by using the energy at the alternating-current side of the inverter, so that the charging power and the response speed of the direct-current coupling system can meet a higher requirement, thereby preventing the photovoltaic panel from being subjected to energy backflow. Moreover, during frequency regulation scheduling in the CVT mode, the inverter automatically regulates the charging power in response to a demand of the battery system, thus solving the problems of high voltage derating of the bus and the regulation saturation without reducing the frequency regulation capability.

The same or similar parts among the embodiments in this specification may be referred to each other, and each of the embodiments emphasizes differences from other embodiments. In particular, the system or embodiments of the system is basically similar to the method embodiment, and therefore is described relatively briefly. For relevant details, reference can be made to the corresponding description of the embodiments of the method. The system and embodiments of the system described above are only illustrative, in which the units described as separate components may or may not be physically separated, and the components shown as units may or may not be physical units, that is, may be located in one place, or distributed over multiple network elements. Some or all of the modules may be selected as needed to achieve the purpose of the solution of the embodiments. Those skilled in the art can understand and implement the solution without any creative effort.

Those skilled in the art may further realize that the units and algorithm steps of each example described in conjunction with the embodiments disclosed herein can be implemented by electronic hardware, computer software, or a combination of both. In order to clearly illustrate the interchangeability of hardware and software, components and steps in the embodiments are described generally in terms of functions in the above description. Whether these functions are performed in hardware or software depends on the specific application and design constraints of the technical solution. Those skilled in the art may implement the described functions in various manners for each specific application, while such implementations should not be considered to be beyond the scope of the present disclosure.

Based on the above description of the disclosed embodiments, the features described in various embodiments in this specification may be replaced or combined with each other, so that those skilled in the art can implement or use the present disclosure. Various modifications to these embodiments will be apparent by those skilled in the art, and the generic principles defined herein may be implemented in other embodiments without departing from the spirit or scope of the present disclosure. Hence, the present disclosure is not limited to the embodiments disclosed herein, but shall conform to the widest scope in accordance with the principle and novel features disclosed herein.

1. A direct-current coupling system, comprising:
at least one inverter;
at least one photovoltaic array; and
at least one energy storage system, wherein
an alternating-current side of the at least one inverter is configured to connect a power grid, and a direct-current side of the at least one inverter is connected to the at least one photovoltaic array and the at least one energy storage system through a corresponding direct-current bus;
the at least one energy storage system comprises a battery system and a direct-current/direct-current (DC/DC) converter, and the battery system is connected to a direct-current bus through the DC/DC converter; and
the DC/DC converter is configured to acquire, in response to a power regulation demand at the alternating-current side, energy from the power grid through the inverter connected to the DC/DC converter during charging the battery system.

2. The direct-current coupling system according to claim 1, wherein a predetermined bus voltage value of the inverter is greater than a predetermined bus voltage value of the DC/DC converter.

3. The direct-current coupling system according to claim 2, wherein
a voltage of the corresponding direct-current bus is controlled by the predetermined bus voltage value of the DC/DC converter, in a case that the battery system completely absorbs energy of the inverter connected to the battery system; and
a voltage of the corresponding direct-current bus is controlled by the predetermined bus voltage value of the inverter, in a case that the battery system fails to completely absorb energy of the inverter connected to the battery system.

4. The direct-current coupling system according to claim 3, wherein
the voltage of the corresponding direct-current bus is decreased as an available charging power of the DC/DC converter is increased; and
the voltage of the corresponding direct-current bus is automatically increased as an available charging power of the DC/DC converter is decreased.

5. The direct-current coupling system according to claim 2, wherein the predetermined bus voltage value of the inverter is positively correlated with an output power of the photovoltaic array connected to the inverter.

6. The direct-current coupling system according to claim 5, wherein the predetermined bus voltage value of the inverter is a maximum system voltage, wherein
an output power of the photovoltaic array connected to the inverter is within a preset fluctuation range comprising zero, and the maximum system voltage is an open circuit voltage of the photovoltaic array connected to the inverter.

7. The direct-current coupling system according to claim 2, wherein the predetermined bus voltage value of the inverter is within a preset range, wherein
an upper limit of the preset range is a high voltage derating lower threshold of the inverter; and
a lower limit of the preset range is an over-adjustment threshold of the inverter.

8. The direct-current coupling system according to claim 2, wherein the predetermined bus voltage value of the DC/DC converter is a system balance voltage, and the system balance voltage is a maximum power point tracking voltage of the photovoltaic array connected to the DC/DC converter.

9. The direct-current coupling system according to claim 2, wherein the DC/DC converter is configured to acquire remaining energy required by the battery system from the photovoltaic array during charging the battery system, if the energy acquired from the power grid is not sufficient for energy required by the battery system.

10. The direct-current coupling system according to claim 1, further comprising a direct-current switch arranged between the at least one photovoltaic array and the direct-current bus connected to the at least one photovoltaic array, wherein
the direct-current switch is off during charging the battery system.

11. The direct-current coupling system according to claim 10, wherein a bus voltage of the inverter is controlled in a constant voltage technology mode during charging the battery system.

12. The direct-current coupling system according to claim 10, wherein before the direct-current switch is turned off, the inverter connected to the direct-current switch operates at zero power, and the DC/DC converter connected to the direct-current switch is on standby.

13. The direct-current coupling system according to claim 1, wherein the DC/DC converter is turned off if the battery system is fully charged.

14. A charging control method for a direct-current coupling system, applied to the direct-current coupling system according to claim 1, wherein the at least one photovoltaic array in the direct-current coupling system is connected to the at least one inverter during charging the battery system,
wherein during charging the battery system, the charging control method comprises:
determining, by the at least one inverter, a second voltage for a charging balance of the battery system and a first voltage in a real time manner, and sending, by the at least one inverter, the second voltage to respective DC/DC converter connected to the at least one inverter, wherein the first voltage is greater than the second voltage;
controlling the at least one inverter to operate on condition that the first voltage serves as a predetermined bus voltage value of the inverter; and
controlling the DC/DC converter to operate on condition that the second voltage serves as a predetermined bus voltage value of the DC/DC converter.

15. The charging control method according to claim 14, wherein the determining a first voltage in a real time manner comprises:
determining a maximum system voltage as the first voltage.

16. The charging control method according to claim 15, wherein the determining a maximum system voltage as the first voltage comprises:
determining a high voltage derating lower threshold of the inverter as a default value of the first voltage;
regulating the first voltage in a real time manner based on an output power of the photovoltaic array connected to the inverter; and
limiting the first voltage within the preset range to obtain a limited value, and determining the limited value as the first voltage.

17. The charging control method according to claim 16, wherein the regulating the first voltage in a real time manner based on an output power of the photovoltaic array connected to the inverter comprises:
determining a preset step size based on an output power rating of the photovoltaic array connected to the inverter;
determining a sum of the preset step size and a previous first voltage as the first voltage, in a case that the output power of the photovoltaic array connected to the inverter is greater than an upper limit of a preset fluctuation range;
determining a value obtained by subtracting the preset step size from the previous first voltage as the first voltage, in a case that the output power of the photovoltaic array connected to the inverter is less than a lower limit of the preset fluctuation range; and
determining an open circuit voltage of the photovoltaic array connected to the inverter as the first voltage, in a case that the output power of the photovoltaic array connected to the inverter is within the preset fluctuation range comprising zero.

18. The charging control method according to claim 14, wherein the determining a second voltage for a charging balance of the battery system in a real time manner comprises:
detecting a maximum power point tracking voltage of the photovoltaic array connected to the DC/DC converter in a real time manner based on a maximum power point tracking strategy, and determining the detected maximum power point tracking voltage as the second voltage.

19. A charging control method for a direct-current coupling system, applied to the direct-current coupling system according to claim 1, wherein the at least one photovoltaic array in the direct-current coupling system is connected to the direct-current bus through a direct-current switch,
wherein during charging the battery system, the charging control method comprises:
turning off the direct-current switch by the at least one inverter in the direct-current coupling system; and
controlling by the at least one inverter, a bus voltage of the inverter in a constant voltage technology mode.

20. The charging control method according to claim 19, wherein before the turning off the direct-current switch by the at least one inverter, the charging control method further comprises:
controlling by the at least one inverter, a power of the inverter to be zero on receipt of a zero-power instruction;
controlling respective DC/DC converter connected to the at least one inverter to enter a standby state on receipt of a standby instruction, and
wherein after the turning off the direct-current switch by the at least one inverter, the charging control method further comprises:
switching a state of the DC/DC converter from the standby state to an operating state on receipt of an operating instruction.
